(19) United States
(12) Patent Application Publication
(10) Pub. No.: US 2022/0027902 A1
(43) Pub. Date: Jan. 27, 2022

(54) DECENTRALIZED SYSTEM FOR FRACTIONALIZED TOKENS

(71) Applicant: Collectible Holdings Inc., El Segundo, CA (US)

(72) Inventors: Evan Vandenberg, El Segundo, CA (US); Till Mueller, El Segundo, CA (US); Thomas Mack, El Segundo, CA (US)

(73) Assignee: Collectible Holdings Inc., El Segundo, CA (US)

(21) Appl. No.: 17/494,709

(22) Filed: Oct. 5, 2021

Related U.S. Application Data
(63) Continuation-in-part of application No. 17/387,768, filed on Jul. 28, 2021.

(51) Int. Cl. G06Q 20/38; G06Q 40/02; G06Q 20/40

(52) U.S. Cl. CPC G06Q 20/3825; G06Q 2220/00; G06Q 20/401; G06Q 40/02

(57) ABSTRACT

Systems and methods for administering fractionalized interests in assets in a decentralized network are described. In some embodiments, a system may be configured to receive a first plurality of fungible tokens representing fractionalized interests in a first asset and a second plurality of fungible tokens representing fractionalized interests in a second asset. The system may be configured to receive a message from a user. In response to receiving the message from the user, the system may be configured to transfer to the user a randomized set of fungible tokens to the user, the randomized set comprising one or more of the fungible tokens of both the first plurality of fungible tokens and the second plurality of fungible tokens.

### CROSS-REFERENCE TO RELATED APPLICATION

This application is a continuation-in-part of U.S. application Ser. No. 17/387,768, filed Jul. 28, 2021, which is incorporated by reference in its entirety.

### FIELD OF THE DISCLOSURE

This disclosure relates to systems and methods for generating, transferring, and redeeming fractionalized interests in assets. More particularly, this disclosure relates to systems and methods that may be used to manage fractionalized interests in assets using decentralized ledgers.

### BACKGROUND

Many items are acquired, in part, due to an anticipation that the items will appreciate in value. For example, rare or unique items, such as art, trading cards (e.g., baseball cards), or other collectors' items, may be acquired, held for some period of time, and later sold. There may be a perceived value for such items based on sale prices for other items that are perceived to be comparable. Generally, however, any given item is sold infrequently, so the value for that item may be uncertain. Similarly, there may be few or no sales of comparable items within a relevant window, which may also increase uncertainty. As a result, prices may fluctuate significantly from one sale to the next, and purchasers may lose significant amounts of money based on volatility. Moreover, the cost of purchasing an entire item may be prohibitive for some individuals who may wish to purchase the item.

Fractionalized interests in business entities and commodities can be achieved through exchange traded funds and similar models, but such models may be subject to significant legal and regulatory requirements necessitated by the centralized management performed by employees, managers, officers, and directors. The compliance and personnel costs associated with centralized management of fractionally owned assets often renders fractional ownership cost-prohibitive.

Accordingly, there is a need for systems and methods that allow fractionalized interests in physical items to be generated, transferred, and redeemed for the original asset, and which provide these benefits in a cost-effective manner. Further, there is a need for robust markets for these types of fractionalized interests that can facilitate more accurate valuations for the physical assets.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a system for administering fractionalized interests in physical assets in a decentralized network may be provided. The system may include a memory storing instructions defining a smart contract, which may be configured to be stored on a decentralized ledger. The smart contract may be configured to receive, from a first account, a non-fungible token comprising data identifying a physical asset. In some embodiments, the non-fungible token may represent ownership of the physical asset. In response to receiving the non-fungible token, the smart contract may be configured to generate a plurality of fungible tokens of a token category associated with the physical asset, the plurality of fungible tokens comprising a number (N) tokens which collectively represent 100% ownership of the non-fungible token. In some embodiments, the smart contract may be configured to transfer ownership of the plurality of fungible tokens to the first account. The smart contract may be configured to receive, from a second account, a collection of N fungible tokens of the token category associated with the physical asset. In response to receiving, from the second account, the collection of N fungible tokens, the smart contract may be configured to transfer ownership of the non-fungible token to the second account.

In some embodiments, the smart contract may further be configured to burn the tokens of the collection of N fungible tokens, in response to receiving the collection of N fungible tokens from the second account. In some embodiments, the smart contract may be configured to maintain a record indicating present ownership of each of plurality of fungible tokens.

In some embodiments, the smart contract may configured to administer buyout procedures, in which a buyout user may obtain N of the plurality of fungible tokens under rules that prevent or discourage holdouts. For example, the buyout procedures may include steps of: (i) receiving a buyout offer from the buyout user to obtain N of the fungible tokens, the buyout offer indicating a stake value of P tokens held by the buyout user; (ii) initiating a time period during which offers to purchase the P tokens at the stake value may be received; and (iii) if no offer to purchase the P tokens at the stake value is received during the time period, transferring ownership of fungible tokens such that the buyout user holds at least N of the fungible tokens.

In some embodiments, the physical asset indicated by the non-fungible token is held by a custodian that has agreed to release the physical asset upon receipt of the non-fungible token.

In some embodiments, the smart contract may be configured to receive a second non-fungible token comprising data identifying a second physical asset that is equivalent to the first physical asset. In response to receiving the second non-fungible token, the smart contract may generate a second plurality of fungible tokens. The plurality of fungible tokens and the second plurality of fungible tokens may be of the same token category. The second plurality of fungible tokens may also include N tokens.

In some embodiments, a method for administering fractionalized interests in a physical asset may be provided. In some embodiments, the method may be performed by a smart contract configured to be stored on a decentralized ledger. The method may include receiving, from a first account, a non-fungible token comprising data identifying the physical asset. The method may further include generating a plurality of fungible tokens of a token category associated with the physical asset, in response to receiving the non-fungible token. In some embodiments, the plurality of fungible tokens may comprise a number (N) tokens which collectively represent 100% ownership of the non-fungible token. The method may include transferring ownership of the plurality of fungible tokens to the first account. The method may include receiving, from a second account, a collection of N fungible tokens of the token category associated with the physical asset, and in response to receiving, from the second account, the collection of N fungible tokens, transferring ownership of the non-fungible token to the second account.

In some embodiments, the method may include burning the tokens of the collection of N fungible tokens. The step of burning the tokens may be performed in response to receiving, from the second account, the collection of N fungible tokens. The method may include maintaining a record indicating present ownership of each of plurality of fungible tokens.

In some embodiments, the method may include administering buyout procedures, in which a buyout user may obtain N of the plurality of fungible tokens under rules that prevent or discourage holdouts. For example, the buyout procedures may include: (i) receiving a buyout offer from the buyout user to obtain N of the fungible tokens, the buyout offer indicating a stake value of P tokens held by the buyout user; (ii) initiating a time period during which offers to purchase the P tokens at the stake value may be received; and (iii) if no offer to purchase the P tokens at the stake value is received during the time period, transferring ownership of fungible tokens such that the buyout user holds at least N of the fungible tokens.

In some embodiments, the physical asset indicated by the non-fungible token may be held by a custodian that has agreed to release the physical asset upon receipt of the non-fungible token.

In some embodiments, the method may include receiving a second non-fungible token, which may comprise data identifying a second physical asset that is equivalent to the first physical asset. The method may include generating a second plurality of fungible tokens in response to receiving the second non-fungible token. The plurality of fungible tokens and the second plurality of fungible tokens may be of the same token category. The second plurality of fungible tokens may include N tokens.

In some embodiments, a system for facilitating exchanges of fractionalized interests in physical assets in a decentralized network may be provided. The system may include a non-transitory computer readable medium containing instructions that, when executed by one or more processors, are configured to cause the one or more processors to receive a first instruction from a first user indicating a willingness to sell one or more fungible tokens. Each of the one or more fungible tokens may represent a fractionalized interest in a category of physical assets. The instructions may further be configured to cause the one or more processors to receive a second instruction from a second user indicating a willingness to buy the one or more fungible tokens, and initiate a transfer of ownership of the one or more fungible tokens to the second user. In some embodiments, the one or more fungible tokens may be generated by a smart contract that is stored on a decentralized ledger. The smart contract may be programmed to receive, from a first account, a non-fungible token. The non-fungible token may comprise data identifying a physical asset within the category of physical assets. The smart contract may be configured to generate a plurality of fungible tokens of a token category associated with the physical asset in response to receiving the non-fungible token. The plurality of fungible tokens may comprise a number (N) tokens which collectively represent 100% ownership of the non-fungible token. The smart contract may be configured to transfer ownership of the plurality of fungible tokens to the first account. In some embodiments, the smart contract may be further configured to receive, from a second account, a collection of N fungible tokens of the token category associated with the physical asset, and in response to receiving, from the second account, the collection of N fungible tokens, transfer ownership of the non-fungible token to the second account.

In some embodiments, the exchange may be configured to transmit transaction data to the smart contract. In some embodiments, the smart contract may be configured to burn the tokens of the collection of N fungible tokens. In some embodiments, the step of burning the tokens may be performed in response to receiving, from the second account, the collection of N fungible tokens. In some embodiments, the smart contract may be configured to maintain a record indicating present ownership of each of plurality of fungible tokens.

In some embodiments, the smart contract may be configured to administer buyout procedures, in which a buyout user may obtain N of the plurality of fungible tokens under rules that prevent or discourage holdouts. In some embodiments, the buyout procedures may include: (i) receiving a first offer from the buyout user to obtain N of the fungible tokens; (ii) initiating a time period during which a second offer to obtain N of the fungible tokens at a higher price than the first offer may be received; and (iii) if no second offer at a higher price than the first offer is received during the time period, transferring ownership of N of the fungible tokens to the buyout user.

In some embodiments, the physical asset indicated by the non-fungible token may held by a custodian that has agreed to release the physical asset upon receipt of the non-fungible token. In some embodiments, the smart contract may be configured to receive a second non-fungible token comprising data identifying a second physical asset that is equivalent to the first physical asset. The smart contract may be configured to generate a second plurality of fungible tokens in response to receiving the second non-fungible token. The plurality of fungible tokens and the second plurality of fungible tokens may be of the same token category, and the second plurality of fungible tokens may comprise N tokens.

In some embodiments, the exchange system may be further configured to take custody of the one or more fungible tokens. The exchange system may be configured to maintain a record indicating ownership of the one or more tokens. In some embodiments, the step of initiating a transfer of ownership of the one or more fungible tokens to the second user may include updating the record to reflect a change of ownership from the first user to the second user without recording the ownership transfer on the decentralized ledger or the smart contract.

In some embodiments, a system for administering fractionalized interests in physical assets in a decentralized network may be provided. The system may include a non-transitory computer readable medium and one or more processors. The system may be configured to receive a first plurality of fungible tokens, each of which represents a fractionalized interest in a first asset. In some embodiments, the system may also be configured to receive a second plurality of fungible token, each of which represents a fractionalized interest in a second asset. The system may further be configured to receive a message from a user. In some embodiments, this message may be a purchase offer. The system may be configured to, in response from receiving the message from the user, transfer to the user a randomized set of fungible tokens to the user. In some embodiments, the randomized set may comprise one or more of the fungible tokens of both the first plurality of fungible tokens and the second plurality of fungible tokens.

In some embodiments, the system may be further configured to generate the first and second plurality of fungible tokens by a smart contract. The smart contract may be configured to receive, from a first account, a non-fungible token, the non-fungible token comprising data identifying the first asset. In some embodiments, the smart contract may be further configured to generate a set of fungible tokens of a token category associated with the first asset in response to receiving the non-fungible token. In some embodiments, the smart contract may be configured so that the set of fungible tokens comprises a number (N) tokens which collectively represent 100% ownership of the non-fungible token.

In some embodiments, the smart contract may be configured to administer buyout procedures, in which a buyout user may obtain N tokens which collectively represent 100% ownership of the first assets under rules that prevent or discourage holdouts. For example, the buyout procedures may include steps of: (i) receiving a buyout offer from the buyout user to obtain N of the fungible tokens, the buyout offer indicating a stake value of P tokens held by the buyout user; (ii) initiating a time period during which offers to purchase the P tokens at the stake value may be received; and (iii) if no offer to purchase the P tokens at the stake value is received during the time period, transferring ownership of fungible tokens such that the buyout user holds at least N of the fungible tokens.

In some embodiments, the randomized set may be configured to comprise a different number of fungible tokens of the first plurality than the second plurality.

In some embodiments, the system may be configured to select the fungible tokens that comprise the set of fungible tokens based, at least in part, on a market value of the fungible tokens.

In some embodiments, the randomized set may be configured to further comprise fungible tokens of a third plurality of fungible tokens. Each token of the third plurality may be configured to represent a fractionalized interest in a third asset.

In some embodiments, the system may further be configured to transfer to the user, in response to receiving the message from the user, a second randomized set, the second randomized set comprising one or more fungible tokens representing factionalized interest in a plurality of assets.

In some embodiments, the first asset and second asset indicated by the first and second plurality of fungible tokens may be physical assets held by a custodian.

In some embodiments, the first asset and second asset indicated by the first and second plurality of tokens may by non-fungible tokens held in a digital wallet.

In some embodiments, the system may be configured to receive, from the user, at least one of a buy order and a sell order for fungible tokens of the first plurality of fungible tokens representing fractionalized interest in the first asset.

In some embodiments, the fungible tokens of the first plurality may represent fractionalized interest in a first non-fungible token. The non-fungible token may comprise data identifying the first asset, and the fungible tokens of the second plurality may represent fractionalized interest in a second non-fungible token comprising data identifying the second asset.

In some embodiments, the system may be configured to receive a fourth plurality of tokens comprising a number (N) of tokens. Each token within the fourth plurality of tokens may represent a fractionalized interest in both the first asset and the second asset as a collective such that the number (N) tokens may collective represent 100% ownership in both the first asset and the second asset. In some embodiments, the fourth plurality of tokens may represent a fractionalized interest in both the first non-fungible token and the second non-fungible token as a collective such that the number (N) tokens may collectively represent 100% in both the first non-fungible token and the second non-fungible token.

In some embodiments, a method for administering fractionalized interests in a physical asset may be provided. In some embodiment, the method may include receiving a first plurality of fungible tokens, each of which represents a fractionalized interest in a first asset. In some embodiments, the method may also include receiving a second plurality of fungible tokens, each of which represents a fractionalized interest in a second asset. The method may further include receiving a message from a user. In some embodiments, this message may be a purchase offer. In some embodiments, the method may include, in response from receiving the message from the user, transferring to the user a randomized set of fungible tokens to the user. In some embodiments, the randomized set may comprise one or more of the fungible tokens of both the first plurality of fungible tokens and the second plurality of fungible tokens.

In some embodiments, the method may include generating the first and second plurality of fungible tokens by a smart contract. The smart contract may be configured to receive, from a first account, a non-fungible token, the non-fungible token comprising data identifying the first asset. In some embodiments, the smart contract may be further configured to generate a set of fungible tokens of a token category associated with the first asset in response to receiving the non-fungible token. In some embodiments, the smart contract may be configured so that the set of fungible tokens comprises a number (N) tokens which collectively represent 100% ownership of the non-fungible token.

In some embodiments, the method may include administering buyout procedures, in which a buyout user may obtain N tokens which collectively represent 100% ownership of the first assets under rules that prevent or discourage holdouts. For example, the buyout procedures may include steps of: (i) receiving a buyout offer from the buyout user to obtain N of the fungible tokens, the buyout offer indicating a stake value of P tokens held by the buyout user; (ii) initiating a time period during which offers to purchase the P tokens at the stake value may be received; and (iii) if no offer to purchase the P tokens at the stake value is received during the time period, transferring ownership of fungible tokens such that the buyout user holds at least N of the fungible tokens.

In some embodiments, the randomized set may be configured to comprise a different number of fungible tokens of the first plurality than the second plurality.

In some embodiments, the method may include selecting the fungible tokens that comprise the set of fungible tokens based, at least in part, on a market value of the fungible tokens.

In some embodiments, the randomized set may be configured to further comprise fungible tokens of a third plurality of fungible tokens. Each token of the third plurality may be configured to represent a fractionalized interest in a third asset.

In some embodiments, the method may include transferring to the user, in response to receiving the message from the user, a second randomized set, the second randomized set comprising one or more fungible tokens representing fractionalized interest in a plurality of assets.

In some embodiments, the first asset and second asset indicated by the first and second plurality of fungible tokens may be physical assets held by a custodian.

In some embodiments, the first asset and second asset indicated by the first and second plurality of fungible tokens may non-fungible tokens held by a digital wallet.

In some embodiments, the method may include receiving, from the user, at least one of a buy order and a sell order for fungible tokens of the first plurality of fungible tokens representing fractionalized interest in the first asset.

In some embodiments, the fungible tokens of the first plurality may represent interest fractionalized interest in a first non-fungible token. The non-fungible token may comprise data identifying the first asset, and the fungible tokens of the second plurality may represent fractionalized interest in a second non-fungible token comprising data identifying the second asset.

In some embodiments, the method may include receiving a plurality of tokens comprising a number (N) of tokens. Each token within the fourth plurality of tokens may represent a fractionalized interest in both the first asset and the second asset as a collective such that the number (N) tokens may collectively represent 100% ownership in both the first asset and the second asset. In some embodiments, the fourth plurality of tokens may represent a fractionalized interest in both the first non-fungible token and the second non-fungible token as a collective such that the number (N) tokens may collectively represent 100% in both the first non-fungible token and the second non-fungible token.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 shows an exemplary system for generating fractionalized interests in an asset.

FIG. 2 shows an exemplary correspondence between assets, NFTs, and tokens.

FIG. 3 shows an exemplary exchange for transferring ownership of tokens representing fractionalized interests in assets.

FIG. 4 shows an exemplary buy-out process.

FIG. 5 shows an exemplary process for redeeming tokens to take possession of a physical asset.

FIG. 6 is a flow chart which shows a method of distributing fractionalized interest in assets.

FIG. 7 shows exemplary correspondence between the system transferring a set of tokens and a user.

FIG. 8 shows an exemplary process for generating tokens representing a fractionalized interest in a collection of assets

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

In some embodiments, a distributed ledger and/or smart contract system may be provided which allows for ownership of an asset to be fractionalized and recorded without centralized management of an underlying item. This may be achieved, for example, by: 1) recording ownership on a distributed ledger which is not proprietary to the seller of the product; 2) fractionalizing ownership using a smart contract deployed to the distributed ledger; and 3) allowing for re-consolidation of ownership in a single owner through interaction with the smart contract. By eschewing centralized management, it may be possible to provide for fractionalized, tradeable interests in assets without necessitating substantial regulatory compliance expenditures.

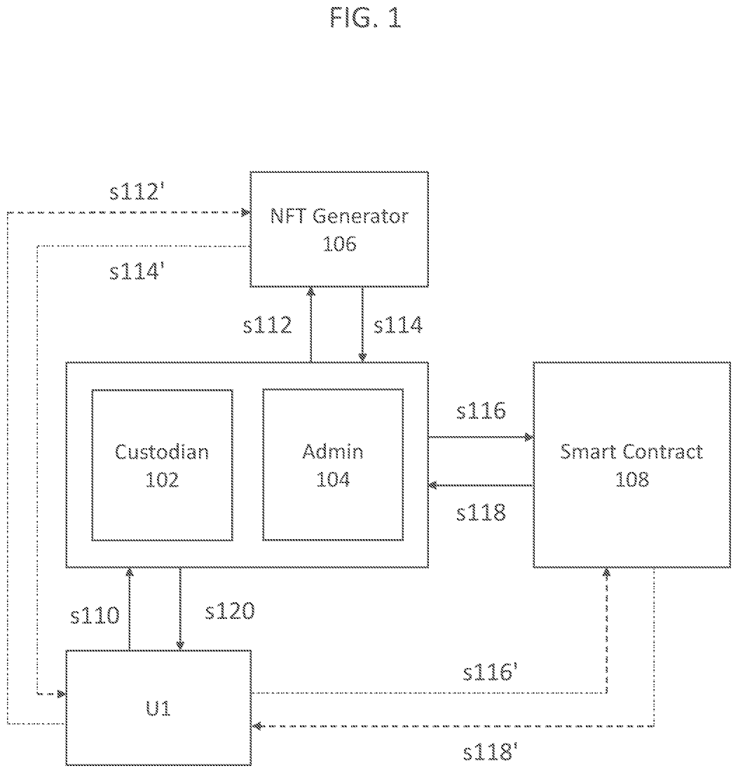

FIG. 1 shows an exemplary system for generating fractionalized interests in a physical asset. In this system, a user U1 may interact with one or more of a custodian 102, an administrator 104, an NFT generator 106, and a smart contract 108. In some embodiments, custodian 102 may be an entity that operates one or more physical facilities in which assets may be deposited and securely stored. In some embodiments, administrator 104 may be an entity that facilitates the systems and processes described herein, e.g., by coordinating transactions between users, custodians, NFT generators, smart contracts, and other relevant entities. The administrator 104 may provide one or more servers, which may receive and transmit messages to perform the functions described herein. In some embodiments, NFT generator 106 may be an entity or module configured to receive information and generate nonfungible tokens (NFTs) containing that information. As used herein, references to an NFT containing information include cases where the information is stored in the NFT itself, as well as cases in which the NFT includes a pointer or reference to the information. In some embodiments, smart contract 108 may be software configured to perform programmed tasks. In some embodiments, smart contract 108 may be stored on a decentralized ledger, such as a blockchain. For example, a smart contract 108 may be programmed and uploaded to a decentralized ledger and then stored in memory at one or more nodes or host computers that maintain and interact with the decentralized ledger.

In step s110, a user U1 may deposit a physical asset with a custodian 102. The user U1 may also transmit payment, which, in some embodiments, may be in the form of a cryptocurrency. This payment may, in some embodiments, be a one-time payment to cover indefinitely the costs associated with custody. The user U1 may also transmit information indicating a digital wallet or account in which the user U1 wishes to receive fractionalized interests corresponding to the deposited physical asset. In some embodiments, the deposit to the custodian 102 may be made indirectly by way of a third party, such as via an administrator 104 or a rating entity. The custodian 102 may hold the physical asset, e.g., in a lockbox, and may release the physical asset only when a user presents appropriate credentials (e.g., a nonfungible token (NFT) corresponding to the asset) to recover the physical asset. The custodian 102 may collect information related to the physical asset. For example, the custodian 102 may collect information regarding the type of asset, its condition, the identity of an entity that authenticated or rated the asset, or any other information that may be considered material. This information may be collected from the user U1, by analyzing the asset, or from a third party with knowledge of the asset, such as a verification or rating entity that has previously analyzed the asset.

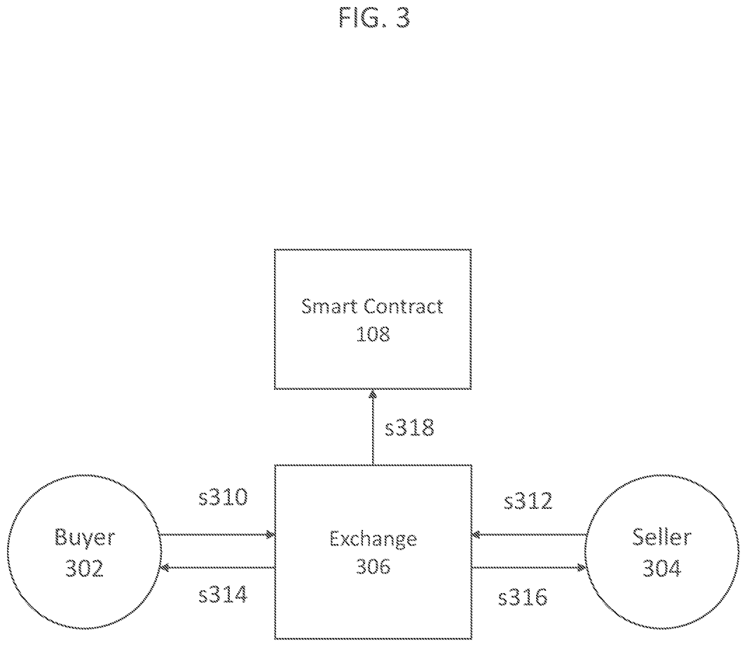

The collected information may then be used to generate a NFT that is specific to the physical asset. In some embodiments, the custodian 102 may transmit the information directly to an NFT generator 106. In other embodiments, the custodian 102 may be associated with an administrating entity 104, which may coordinate actions between users, custodians, NFT generators, and smart contracts. In some embodiments, the administrator 104 may maintain a contract with the custodian 102 specifying terms under which the custodian 102 will hold and release physical assets. For example, the custodian 102 may enter an agreement with the administrator 104 or a user specifying a fee to be paid in exchange for taking custody of the physical asset on an indefinite, fixed time period, or lifetime basis. In some embodiments, the administrator 104 may also administer an exchange for trading fractionalized interests, as described below with respect to FIG. 3.

In step s112, information relating to a physical asset may be transmitted to an NFT generator 106. The information may be transmitted by the custodian 102 or by administrator 104 or smart contract 108 (which may first receive the information from the custodian 102, from the user U1, or from a verification/rating entity). Also in step s112, payment for generating the NFT may be transmitted to the NFT generator 106. In some embodiments, the user U1 may supply this payment. For example, the payment for generating the NFT may be provided directly by user U1, or the payment may be supplied indirectly by U1, such as by collecting a broader fee for holding the physical asset in custody and generating fractionalized interests and by using a portion of that fee to generate the NFT. Such fee handling may be performed by the custodian 102, administrator 104, the smart contract 108, or other appropriate entity.

In step s114, NFT generator 106 may generate and return an NFT that is specific to the physical asset received by custodian 102. For example, the information related to the physical asset may be stored in the NFT or otherwise associated with the NFT. In the case of a trading card, for example, the NFT may contain information indicating one or more of the type of card, the player, its date or edition, its quality or condition, and an entity that verified or evaluated any of the above. The NFT may also contain information related to the custodian holding the physical asset or an administrator involved in the process of generating the NFT and/or fractionalized interests in the physical asset.

In some embodiments, a user U1 may instead interact, directly or indirectly, with the NFT generator 106 as shown in alternative steps s112′ and s114′. For example, before or after an asset is deposited with custodian 102, user U1 may transmit a message in step s112′ to NFT generator 106 providing the information needed to generate an NFT for the deposited asset. In some embodiments, user U1 may first deposit the asset with the custodian 102 and receive from the custodian 102 a unique identifier corresponding to the deposited asset. This exchange may occur, for example, in step s110. In some embodiments, user U1 may alternatively or additionally receive a credential, such as a cryptographic key, that the user U1 must submit to NFT generator 106 to obtain a valid NFT that can be later be presented to the custodian 102 to recover the deposited asset. In some embodiments, the user U1 may submit the identifier and/or credential to the NFT generator 106 with information related to the asset in step s112′. In alternative step s114′, the NFT generator 106 may transmit the NFT to the user U1.

In step s116, the NFT may be transmitted to a smart contract 108. The NFT may be transmitted by custodian 102, administrator 104, or by NFT generator 106. In some embodiments, payment may also be submitted to the smart contract 108 in step s116. In some embodiments, this payment may be provided directly by the user U1. In other embodiments, it may be taken from a fee collected by the custodian 102 or administrator 104, as described above. In some embodiments, the NFT may be transmitted to the smart contract 108 by user U1, as shown in alternative step s116′. Payment may likewise be submitted by the user U1 directly to the smart contract 108.

The smart contract 108 may determine whether the NFT conforms to specification requirements for generating fractionalized interests. For example, the smart contract 108 may determine whether the NFT contains certain data categories for a type of physical asset. If the smart contract 108 determines that the NFT lacks the required properties, the NFT may be rejected. If the smart contract 108 determines that the NFT has the required properties, the smart contract 108 may accept the NFT and hold the NFT in a digital wallet or at a digital address associated with the smart contract 108.

The smart contract 108 may generate a plurality of tokens that are associated with the NFT. In some embodiments, each token may contain information indicating the NFT with which it is associated. In some embodiments, each token may contain information indicating the data related to the physical asset. In step s118, the generated tokens may be transmitted to the entity from which the NFT was received. In some embodiments, the tokens may be transmitted by the smart contract 108 to the administrator 104 or custodian 102. In other embodiments, the tokens may be transmitted by the smart contract directly to the user U1 (as shown in alternative step s118′), or to the NFT generator 106, which may transmit the tokens to the user U1 or to an intermediary such as custodian 102 or administrator 104. In some embodiments, allowing a user U1 to perform transactions directly, as shown in steps s112′, s114′, s116′, and s118′, may enhance the decentralized nature of the system, which may beneficially reduce regulatory complexity.

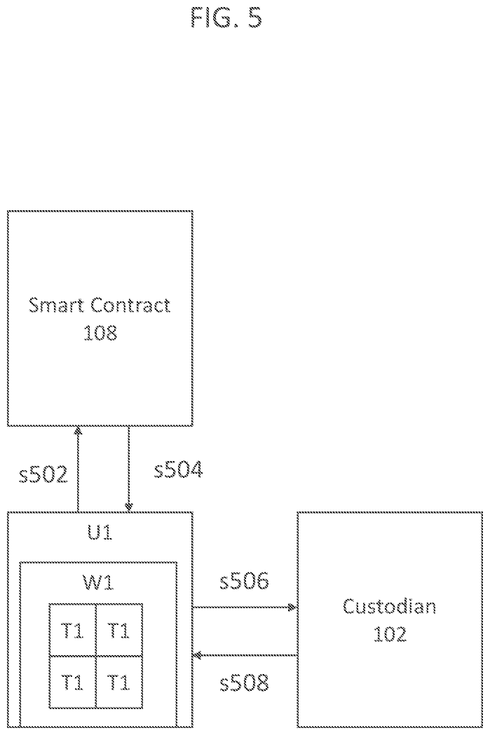

In step s120, the tokens corresponding to the physical asset may be transmitted to the user U1. For example, the tokens may be transferred to a digital wallet or account owned by the user U1. From end-to-end, the user U1 may thus deposit a physical asset and, in return, receive a plurality of tokens representing fractionalized interests in that physical asset. The physical asset may be securely stored by the custodian until a user satisfies conditions required for release of the physical asset. In some embodiments, the physical asset may be released when a user demonstrates possession of, or transmits to the custodian or administrator, the NFT associated with the physical asset. The NFT may be held by the smart contract 108 and released to a user only when the user transmits to the smart contract tokens representing a 100% interest in the physical asset. Exemplary release conditions are described in greater detail below with respect to FIG. 5.

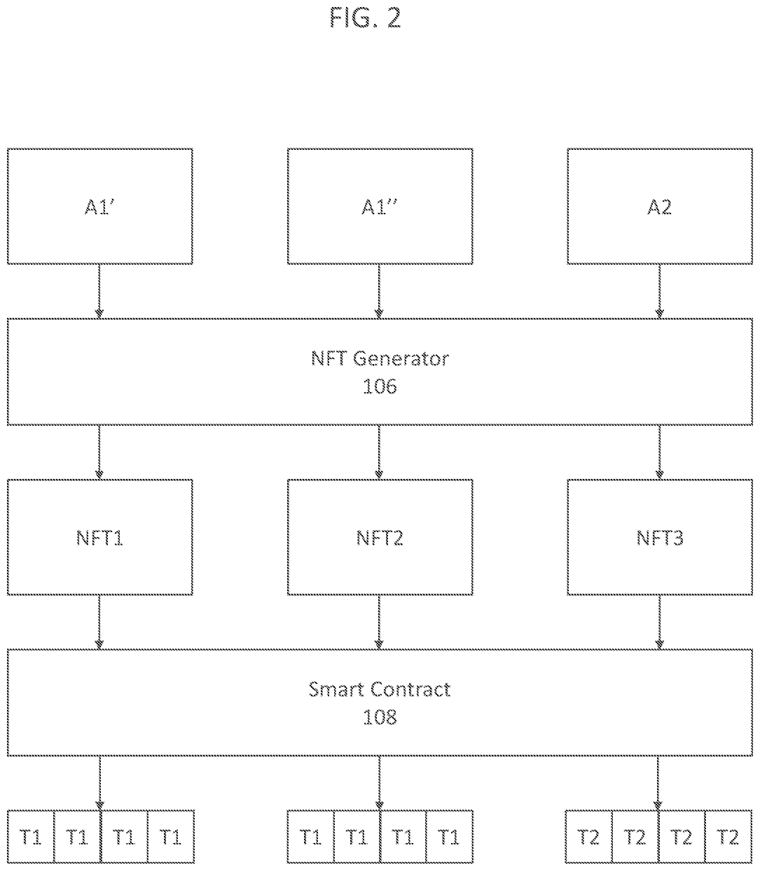

FIG. 2 shows an exemplary correspondence between physical assets, NFTs, and tokens. As shown in FIG. 2, any number of physical assets may be deposited with a custodian. The illustrated embodiment shows three assets A1′, A1″, and A2. In this example, assets A1′ and A1″ are two physically distinct assets which are identical in terms of all of the data fields that will be collected by the system and stored in an NFT corresponding to the assets. A1′ and A1″ may thus be considered equivalent assets. Asset A2 is different, in one or more of these data fields, than assets A1′ and A1″.

The data for each of assets A1′, A1″, and A2 may be passed through NFT generator 106, which may output nonfungible tokens NFT1, NFT2, and NFT3. Each NFT may be unique, but NFT1 and NFT2 may store identical physical asset data. NFT3 may store physical asset data that is different, in one or more data fields, from that stored in NFT1 and NFT2. The NFTs may be transmitted to smart contract 108, which may output a plurality of tokens corresponding to the NFTs and physical assets. In some embodiments, the smart contract may determine that NFT1 and NFT2 contain identical physical asset data, and generate identical tokens or tokens of the same category which correspond equally and may be redeemable for either NFT1 or NFT2 and, in turn, either asset A1′ or asset A1″. In some embodiments, the smart contract 108 may first receive NFT1, issue a first plurality of tokens T1 corresponding to NFT1, and then receive NFT2. The smart contract 108 may determine whether an NFT with identical physical asset data has been previously received and, if so, issue a second plurality tokens T1 that are identical to the first plurality of tokens. Similarly, when NFT3 is received, the smart contract 108 may determine that no NFT with identical asset data has been previously received and, as a result, issue a third plurality of tokens T2, which may be of a different category than tokens T1 and which may not be redeemable for NFTs NFT1 or NFT2.

Any number of tokens T1, T2 may be generated. Assuming, by way of example, that one hundred tokens are generated, each token may represent a 1% interest in the physical asset. If a user held all one hundred tokens (i.e., 100%), the user may have the option to transmit the tokens to the smart contract and receive the corresponding NFT in return. In a case where two NFTs with identical asset data are received by the smart contract, there may be a total of two hundred tokens (again assuming one hundred tokens per NFT). A user holding one hundred tokens (i.e., representing a 100% interest in one of these two NFTs) may have the option to transmit the one hundred tokens to the smart contract and receive one of the corresponding NFTs in return. A second user may later transmit the second one hundred tokens to the smart contract and receive the other of the corresponding NFTs in return. The number of tokens generated per NFT may be chosen arbitrarily. For example, one thousand, ten thousand, one hundred thousand, or one million tokens may be generated per NFT. In each such case, the smart contract may allow users to redeem collections of 100% of the outstanding tokens per NFT to obtain the NFT. In some embodiments, the smart contract may store and update data as to the number of tokens outstanding and the ownership of the tokens.

FIG. 3 shows an exemplary exchange for transferring ownership of tokens representing fractionalized interests in physical assets. The exchange 306 may interact with a plurality of users, which may include a plurality of buyers 302 and sellers 304. In the illustrated example, one buyer and seller are shown, but any number of buyers and sellers may interact with the exchange. The exchange may also interact with a smart contract 108, which may manage issuance, redemption, and track ownership of tokens, as described above with respect to FIGS. 1 and 2.

In step s310, buyer 302 may submit an offer to buy one or more tokens representing fractionalized interests in a physical asset. In step s312, a seller 304, who may own one or more such tokens, may submit an offer to sell the tokens. The exchange 306 may receive a plurality of such buy and sell offers, and where a buy and sell offer are matched, may execute a trade. In step s314, the exchange may notify the buyer that a trade has been executed at the offered price. In step 316, the exchange may notify the seller that a trade has been executed at the offered price. In some embodiments, the exchange may deduct the purchase price from an account held by the buyer (or otherwise collect payment) and transfer the purchase price (optionally, less an exchange fee) to an account held by the seller. Ownership of the tokens may likewise be transferred from the seller to the buyer. In some embodiments, the exchange may take custody of the tokens and maintain internal ledgers indicating ownership of each token. In such embodiments, ownership of tokens may be transferred from one user by updating ledgers internal to the exchange. In other embodiments, the tokens may be transferred to accounts external to the exchange. In optional step s318, the exchange may notify the smart contract 108 when a transaction occurs. In some embodiments, the smart contract may then update records regarding token ownership.

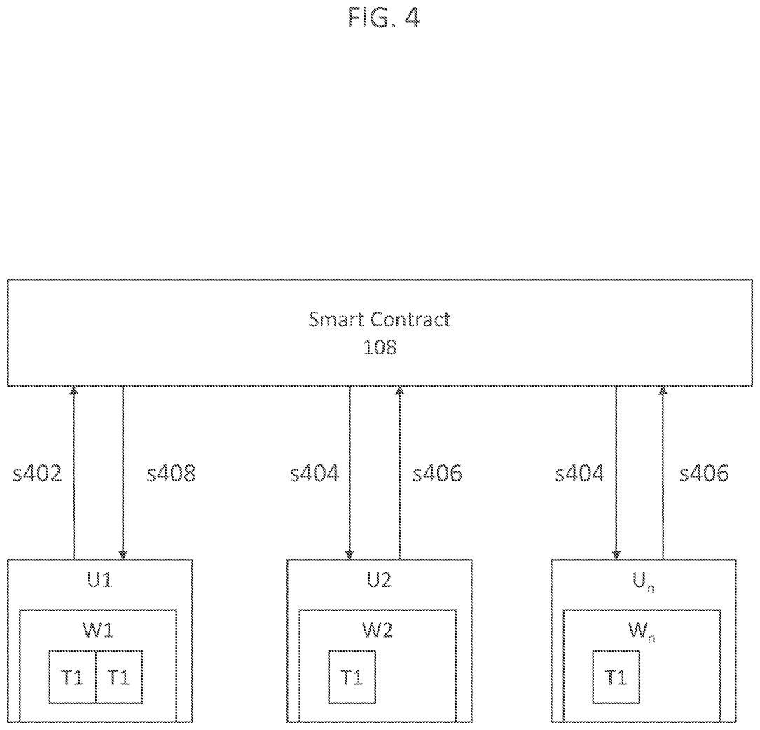

FIG. 4 shows an exemplary buy-out process. In some embodiments, tokens T1 representing fractionalized interests in a physical asset may be held by any number of users U1, U2, Uₙ. To provide a simplified example, user U1 is shown holding two tokens T1 in a wallet W1 owned by user U1, user U2 is shown holding one token T1 in a wallet W2 owned by user U2, and user Uₙ is shown holding one token T1 in a wallet Wₙ owned by user Uₙ. In a typical scenario, many more tokens may be distributed across many more users. The smart contract 108 may be configured to enable users to initiate a buy-out procedure. Such a buy-out procedure may advantageously mitigate or eliminate collective action problems. For example, without a buy-out procedure, users may have an incentive to hold a small interest in a physical asset so that if another user wishes to redeem the fractionalized interests for the asset, they will first need to buy the remaining fractionalized interest from the holdout user, allowing the holdout user to demand an unduly high price. The use of a buy-out procedure, such as that described herein, may prevent such holdouts.

In step s402, user U1 may initiate a buyout procedure. For example, user U1 may transmit a buyout offer to obtain a number N of the tokens T1, where the number N is a number of tokens necessary to redeem the tokens for a corresponding NFT held by the smart contract (which, in turn, may be redeemed for a physical asset held by a custodian). In this case, obtaining N tokens refers to the total number of tokens the user would hold if the buyout offer is executed. For example, in the illustrated example, there are a total of four tokens T1 outstanding, which, if they were held by a single user, would be sufficient to be redeemed for a corresponding NFT. Thus, N is four, and user U1's offer is to obtain a total of four tokens (in this case, by increasing user U1's stake from two to four tokens).

The buyout offer transmitted in step s402 may indicate a stake value of the P tokens held by the buyout user. For example, in the illustrated example, P is two, and the buyer may assign some monetary value to the P tokens being staked under the buyout procedure. In some embodiments, the buyout offer transmitted in step s402 may include a buyout price at which the buyout user U1 is willing to obtain N tokens (e.g., by buying sufficient tokens from users U₂, Uₙ such that user U1 will hold N tokens if the transaction is completed). In some embodiments, the buyout user U1 may be required to submit with the buyout offer a payment equal to the buyout price. The smart contract 108 may hold this payment during a buyout period, and if the buyout offer is successful, the smart contract 108 may use the payment to purchase the tokens from users U₂, Uₙ. If the buyout offer is not successful, the payment may be returned by the smart contract to user U1. In some embodiments, the stake value P may be implied from the buyout price. Submitting a buyout price to obtain N tokens may thus be considered to indicate a stake value of the P tokens held by the buyout user.

In some embodiments, user U1 may also transmit a transaction fee to the smart contract to initiate the buyout procedure.

Upon receipt of the buyout offer in step s402, the smart contract may in step s404 notify other users U2, Uₙ holding token type T1 of user U1's initiated buyout and the stake value of the P tokens. Optionally, users who do not hold token type T1 may not be notified. The smart contract 108 may initiate a time period during which the other users may submit offer to purchase the P tokens at the stake value. In some embodiments, the time period may be any of 6 hours, 12 hours, 1 day, 2 days, 3 days, 5 days, 1 week, or 2 weeks.

In step s406, each user U₂, Uₙ may transmit either an offer to purchase the P tokens at the stake value or a refusal to do so. If the allotted time expires, the smart contract 108 may interpret a lack of response as a refusal. In step s408, the buyout transaction may be settled. If one of the users U2, Uₙ elected to purchase the P tokens at the stake value, ownership of the P tokens may be transferred to that user, and payment may be transferred to the buyout user U1. If all users decline to purchase the P tokens at the stake value or fail to respond within the allotted time period, user U1's buyout may be deemed successful, and tokens T1 may be transferred from the other users U2, Uₙ in a quantity sufficient such that user U1 will have N tokens (i.e., the amount necessary to obtain the NFT and physical asset). Payment may be transferred from U1 to the users U2, Uₙ in an amount implied by the stake value of the P tokens. For example, since the P tokens represent a known share of the N tokens, the stake value for the P tokens implies a corresponding value of the N tokens, which may then be paid to the users U2, Uₙ on a pro rata basis depending on the number of tokens purchased from each respective user. In some embodiments, a buyout price staked by the buyout user U1 and held by the smart contract may be paid to the users U2, Uₙ on a pro rata basis depending on the number of tokens purchased from each respective user.

FIG. 5 shows an exemplary process for redeeming tokens T1 to take possession of a physical asset. In the illustrated example, a user U1 owns a wallet W1 in which all tokens T1 corresponding to an NFT and asset. In step s502, the user may transmit the plurality of tokens T1 to smart contract 108. The smart contract may determine to which NFT the tokens T1 are associated and, upon verification, transfer in step s504 the associated NFT to user U1 (e.g., by assigning ownership of the NFT to wallet W1). The smart contract 108 may burn (e.g., destroy) all of the tokens T1, since the tokens T1 no longer correspond to an NFT held by the smart contract 108.

In step s506, the user U1 may transmit the NFT to the custodian 102. In response, the custodian 102 may verify the NFT and determine whether and to which physical asset the NFT corresponds. In response to receiving a valid NFT corresponding to a physical asset, the custodian 102 may release the physical asset to the user U1, as shown in step s508. In some embodiments, depositing and/or withdrawing a physical asset may be automated. For example, a facility may have a number of lockboxes in which the locks are internet-connected. Upon deposit of a physical asset and activation of a lock, the lockbox transmit a message that initiates the process of generating an NFT and fractionalized tokens as described above with respect to FIG. 1. Upon transmission of the NFT to a lockbox, the lockbox may automatically unlock so that a user can recover the physical asset. In other embodiments, a smart contract, administrator, or custodian may transmit access credentials, such as an access code, to a user and to a lockbox storing a physical asset when the user redeems an NFT or a plurality of tokens representing a 100% interest in the physical asset. The user may then input the access credentials at the lockbox, and the lockbox may, upon validating that the credentials received from the user correspond to those received from the smart contract, administrator, or custodian, unlock to allow the user to take possession of the physical asset.

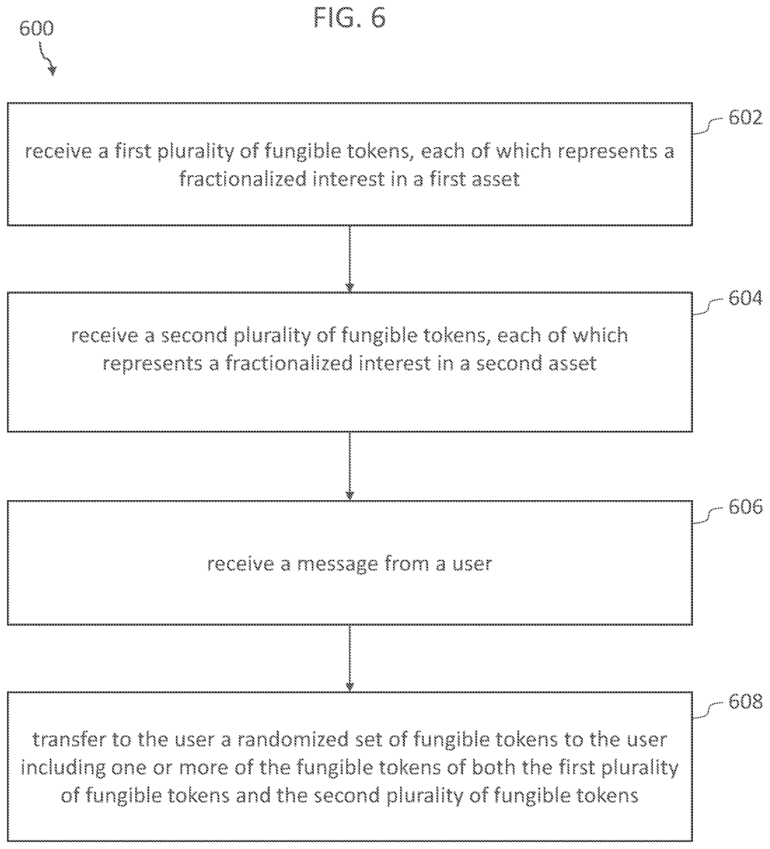

FIG. 6 shows an exemplary method 600 by which a system may transfer fungible tokens into a randomized set of fungible tokens. In some embodiments, method 600 may be performed by an exchange, such as that described above with respect to FIG. 3. Method 600 may alternatively be performed by other entities, such as an administrator, custodian, or smart contract, as described above with respect to FIG. 1. In embodiments where method 600 is performed by a smart contract, a smart contract may be programmed to perform the steps as described herein and stored on a decentralized ledger. Optionally, the smart contract may communicate with another entity (e.g., an administrator, exchange, or other entity) that may supply random or pseudorandom values, which the smart contract may use to select tokens for inclusion in a set. The assets used in method 600 may be any of the assets described with respect to FIGS. 1-5, and method 600 may be combined with any of the systems and techniques described therein. In step 602, the system may receive a first plurality of fungible tokens, each of which represents a fractionalized interest in a first asset. The first asset may comprise a physical asset that may be deposited with a custodian. In some embodiments, there may be a non-fungible token that corresponds to the first asset. The non-fungible token may store physical data that identifies the first asset. In other embodiments, the first asset may be digital. For example, the non-fungible token itself may be the asset of interest. In some embodiments, the first plurality of tokens may represent a fractionalized interest in the non-fungible token.

In step 604, the system may receive a second plurality of fungible tokens, each of which represents a fractionalized interest in a second asset. The second asset may represent a physical asset deposited with a custodian. In some embodiments, there may be a non-fungible token that corresponds to the second asset. The non-fungible token may store physical data that identifies the second asset. In other embodiments, the second asset may be a digital asset (such as, but not limited to a non-fungible token). In some embodiments, the first plurality of tokens may represent a fractionalized interest in the non-fungible token. In some embodiments, the amount of fungible tokens comprising the second plurality of fungible tokens may be different than the amount of fungible tokens comprising the first plurality of fungible tokens.

In step 606, the system may receive a message from a user. In some embodiments, the message may comprise a purchase request. In other embodiments, the message may transmit a payment, which in some embodiments, may be in the form of a cryptocurrency. In other embodiments, the message may indicate that the user has performed an action that triggers compensation or a reward. For example, the message may indicate that a user has made an initial deposit with the system or has registered a new asset. The message may also transmit information indicating a digital wallet or account which the user wishes to receive the randomized set of fungible tokens.

In step 608, the randomized set may be transferred to the user. Step 608 may be performed in response to receipt of the message in step 606. In some embodiments, the randomized set may be transferred to the user via a smart contract. In some embodiments, the randomized set may be transferred to the digital wallet that may have been provided in the message from the user. The randomized set may comprise one or more of the fungible tokens of both the first plurality of fungible tokens and the second plurality of fungible tokens. In some embodiments, the set may be comprised of a different number of fungible tokens from the first plurality than from the second plurality.

Before transmitting to the user the randomized set of fungible tokens, the system may select tokens to include in the randomized set. In some embodiments, all assets may have an equal probability of being included in the randomized set. In other embodiments, certain assets may be more likely than others to be included in the randomized set, certain assets may be excluded from inclusion in the randomized set, or randomized sets may be selected from a predesignated pool of eligible assets. In some embodiments, a probability function may be used that weights assets for inclusion in a randomized set based on a market value of each asset. Optionally, the market value may be one among a plurality of factors that the probability function considers. Other factors may include whether the asset is a physical asset, a trading card, the player listed, the date the asset was created, its condition, when the asset was registered with an exchange system, trading volume for the asset, or volatility for the asset. In other embodiments, a system may define a pool of assets from which randomized sets can be generated. In some embodiments, the pool may be defined based on market value of the assets. In some embodiments, additional factors may be considered (e.g., whether the asset is a physical asset, a trading card, the player listed, the date the asset was created, its condition, when the asset was registered with an exchange system, trading volume for the asset, or volatility for the asset). The randomized set may include tokens corresponding to any number of assets (e.g., 1, 2, 3, 4, 5, 10, 20, 50, or 100 assets), and any number of randomized sets may be transmitted to a user in response to one or more messages received from the user.

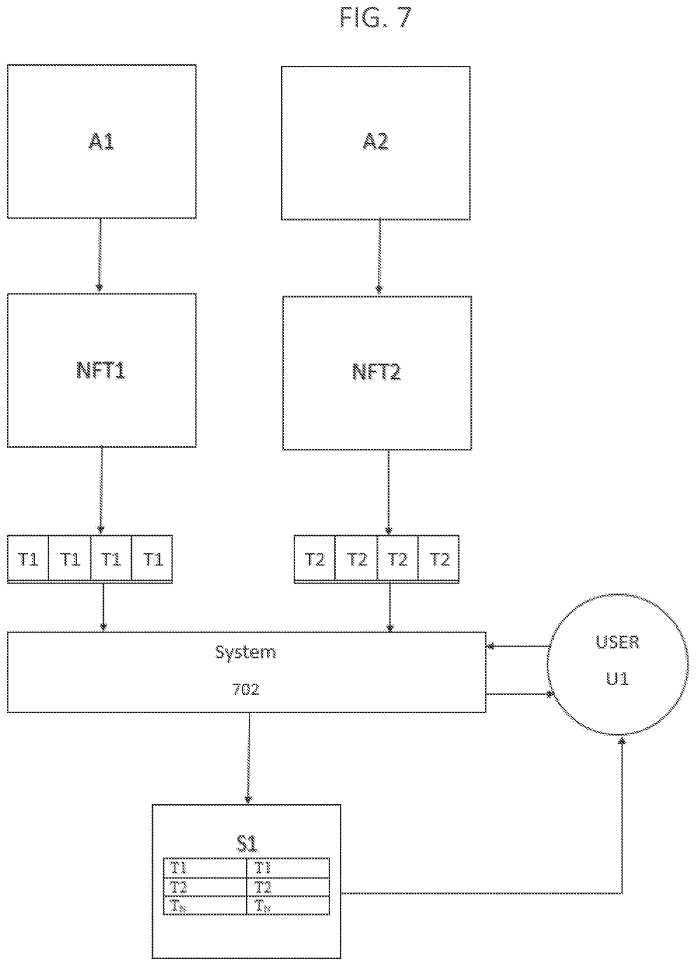

FIG. 7 shows exemplary correspondence between the system transferring the tokens and the user. Although two assets are shown in FIG. 7, it should be understood that any number of assets, NFTs, and tokens may be used. In this system, a user U1, may interact with a system 702. In some embodiments, the asset A1 may be a physical asset deposited with a custodian, and the asset A2 may be a second physical asset deposited with a custodian. In some embodiments, the non-fungible tokens NFT1 and NFT2 may be generated using a smart contract. A non-fungible token NFT1 may correspond to the asset A1, and a non-fungible token NFT2 may correspond to the asset A2.

In some embodiments, the asset Al may be the non-fungible token NFT1, and the second asset A2 may be the second non-fungible token NFT2 (e.g., the NFTs themselves may be the assets of value). In other embodiments, the NFTs may represent other types of digital assets.

A plurality of fungible tokens T1 may correspond to NFT1, and a plurality of fungible tokens T2 may correspond to NFT2. In some embodiments, the amount of tokens comprising T1 may be different than the amount of tokens comprising T2. In some embodiments, the fungible tokens T1, T2 may be generated using a smart contract as described above with respect to FIGS. 1, 2, and 4.

The system 702 may comprise non-transitory computer readable medium and one or more processors. In some embodiments, the system may receive the plurality of tokens T1 and T2. In some embodiments, the system 702 may be an exchange or administrator, as described in FIGS. 1 and 3.

The system 702 may select some tokens from T1 and T2 for a randomized set of fungible tokens S1. In some embodiments, the selection of T1 and T2 may be based, at least partially, on the market value of the fungible tokens. In some embodiments, the system selects fungible tokens based on a market value of the fungible tokens. For example, the system may use a probability function that weights tokens for selection based on their market values. In some embodiments, fungible tokens may only be eligible for selection if the market value of the fungible tokens falls within a certain range. In some embodiments, the system may utilize a smart contract when selecting the tokens for S1. The amount of tokens T1 within the randomized set S1 may be different than the amount of coins T2 within the randomized set S1. Set S1 may also include tokens corresponding to any number of additional assets and/or NFTs, as indicated by T_{N}.

The system may receive a message from a user U1. In some embodiments, the message may comprise a purchase offer. In some embodiments, the message may transmit a payment, which in some embodiments, may be in the form of a cryptocurrency. The message may also transmit information indicating a digital wallet or account that the user wishes to receive the randomized set of fungible tokens. In some embodiments, the user U1 may utilize a smart contract when sending the message to the system. In some embodiments, the system send a response message back to the user U1. In some embodiments, the response message may confirm that the system received the message from the user U1. In some embodiments, the response message may request that the user U1 confirm the information indicating the digital wallet or account provided in the message from the user U1. In some embodiments, the system may utilize a smart contract when sending the response message to the user U1.

In some embodiments, the system may transfer the set S1 to user User1 in response to receiving the message. In some embodiments, multiple sets may be transferred to the user in response to receiving the message. In some embodiments, the user may transmit multiple messages to the system, and the system may transmit one or more randomized sets in response to each of the received messages.

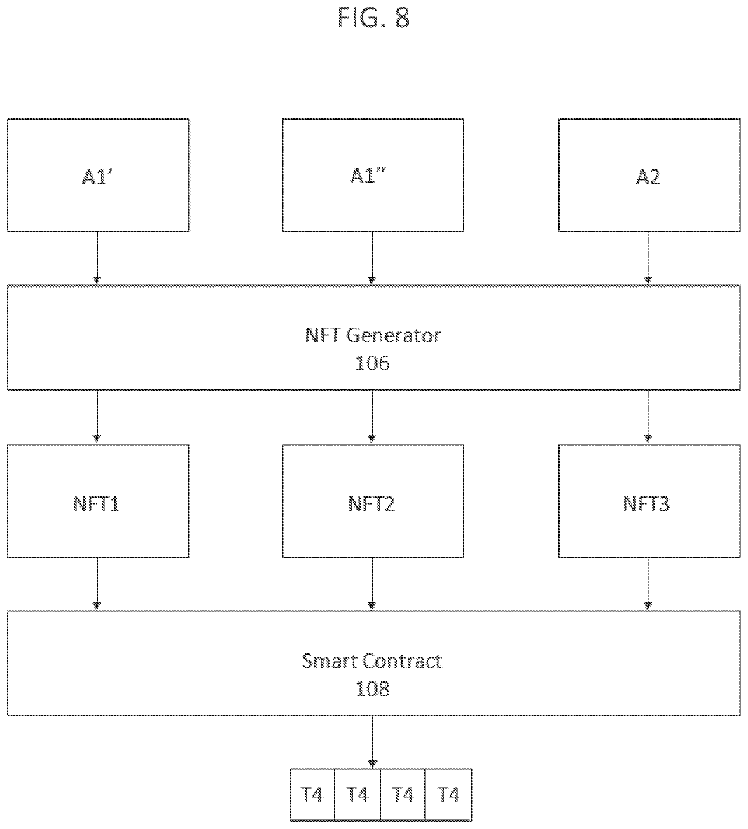

FIG. 8 shows an exemplary process for generating tokens representing a fractionalized ownership in a collection of assets. As shown in FIG. 8, any number of physical or digital assets may be used. In some embodiments, the assets used may be physical assets which may be deposited with a custodian. The illustrated embodiment shows three assets A1′, A1″, and A2. In this example, assets A1′ and A1″ are two physically distinct assets which are identical in terms of all of the data fields that may be collected by the system and stored in an NFT corresponding to the assets. A1′ and A1″ may thus be considered equivalent assets. Asset A2 is different, in one or more of these data fields, than assets A1′ and A1″.

The data for each of assets A1′, A1″, and A2 may be passed through NFT generator 106, which may output non-fungible tokens NFT1, NFT2, and NFT3. Each NFT may be unique, but NFT1 and NFT2 may store identical physical asset data. NFT3 may store physical asset data that is different, in one or more data fields, from that stored in NFT1 and NFT2.

In other embodiments, the assets may be entirely digital. For example, the NFTs (e.g., NFT1, NFT2, NFT3) may themselves be the assets of value, and they may not correspond to any physical asset. In other embodiments, some NFTs may correspond to physical assets, and other NFTs may be or correspond to all-digital assets. In the case of all digital assets, the use of an NFT generator may be omitted, as the NFT (or other digital asset) may pre-exist the use of the system.

In the illustrated embodiment, the NFTs may be transmitted to smart contract 108, which may output a plurality of tokens corresponding to the NFTs and physical assets. In some embodiments, the smart contract may issue a plurality of tokens T4 which correspond to NFT1, NFT2, and NFT3 as a collection. Each token T4 may thus represent a fractional interest in a collection of multiple assets. In a trading card example, a class of tokens may be generated that corresponds to a multiple trading cards for a given player, or for multiple trading cards for a rookie class for a given year. The “collection” tokens T4 may be used, exchanged, and redeemed in the same way as the fungible tokens described above with respect to FIGS. 1-5.

Any number of tokens T4 may be generated. Assuming, by way of example, that one hundred tokens are generated, each token may represent a 1% interest in the collection of physical assets. If a user held all one hundred tokens (i.e., 100%), the user may have the option to submit the tokens in the smart contract and receive the corresponding collection of NFTs. The number of tokens generated per NFT may be chosen arbitrarily. For example, one thousand, ten thousand, one hundred thousand, or one million tokens may be generated per collection of NFTs. In each such case, the smart contract may allow users to redeem collections of 100% of the outstanding tokens per collection of NFTs to obtain the NFTs within the collection of NFTs. In cases where the NFTs represent physical assets, the user may then redeem the collection of NFTs to take possession of the corresponding collection physical assets, using the process described above with respect to FIG. 5. The smart contract may store and update data as to the number of tokens outstanding and the ownership of the tokens.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A system for administering fractionalized interests in assets in a decentralized network, the system comprising:
a non-transitory computer readable medium and one or more processors, the system being configured to:
receive a first plurality of fungible tokens, each of which represents a fractionalized interest in a first asset;
receive a second plurality of fungible tokens, each of which represents a fractionalized interest in a second asset;
receive a message from a user; and
in response to receiving the message from the user, transfer to the user a randomized set of fungible tokens to the user, the randomized set comprising one or more of the fungible tokens of both the first plurality of fungible tokens and the second plurality of fungible tokens.

2. The system of claim 1, wherein fungible tokens of the first plurality of fungible tokens and the second plurality of fungible tokens are generated by a smart contract, the smart contract being configured to:
receive, from a first account, a non-fungible token, the non-fungible token comprising data identifying the first asset;
in response to receiving the non-fungible token, generate a set of fungible tokens of a token category associated with the first asset, the set of fungible tokens comprising a number (N) tokens which collectively represent 100% ownership of the non-fungible token.

3. The system of claim 2, wherein the smart contract is further configured to:
administer buy out procedures in which a buyout user may obtain N tokens which collectively represent 100% ownership of the first asset under rules that prevent or discourage holdouts, the buyout procedures comprising:
receiving a buyout offer from the buyout user to obtain a N fungible tokens representing fractionalized interest in the first asset, the buyout offer indicating a stake value of P fungible tokens held by the buyout user;
initiating a time period during which offers to purchase the P tokens at the stake value may be received; and
if no offer to purchase the P tokens at the stake value is received during the time period, transferring ownership of fungible tokens such that the buyout user holds at least N of the fungible tokens representing fractionalized interests in the first asset.

4. The system of claim 1, wherein the randomized set comprises a different number of fungible tokens of the first plurality than the second plurality.

5. The system of claim 1, wherein the system is further configured to:
select the fungible tokens that comprise the set of fungible tokens based, at least in part, on a market value of the fungible tokens.

6. The system of claim 1, wherein the randomized set further comprises fungible tokens of a third plurality of fungible tokens, each token of the third plurality of fungible tokens representing a fractionalized interest in a third asset.

7. The system of claim 1, wherein the system is further configured to transfer to the user, in response to receiving the message from the user, a second randomized set, the second randomized set comprising one or more fungible tokens representing fractionalized interests in a plurality of assets.

8. The system of claim 1, wherein the first asset and second asset are each physical assets held by a custodian.

9. The system of claim 1, wherein the system is further configured to:
receive, from the user, at least one of a buy order and a sell order for fungible tokens of the first plurality of fungible tokens representing fractionalized interests in the first asset.

10. The system of claim 1, wherein the fungible tokens of the first plurality represent fractionalized interests in a first nonfungible token comprising data identifying the first asset, and the fungible tokens of the second plurality represent fractionalized interest in a second nonfungible token comprising data identifying the second asset.

11. A method for administering fractionalized interests in assets in a decentralized network, the method comprising:
receiving a first plurality of fungible tokens, each of which represents a fractionalized interest in a first asset;
receiving a second plurality of fungible tokens, each of which represents a fractionalized interest in a second asset;
receiving a message from a user; and
in response to receiving the message from the user, transferring to the user a randomized set of fungible tokens to the user, the randomized set comprising one or more of the fungible tokens of both the first plurality of fungible tokens and the second plurality of fungible tokens.

12. The method of claim 11, wherein fungible tokens of the first plurality of fungible tokens and the second plurality of fungible tokens are generated by a smart contract, the smart contract being configured to:
receive, from a first account, a non-fungible token, the non-fungible token comprising data identifying the first asset;
in response to receiving the non-fungible token, generate a set of fungible tokens of a token category associated with the first asset, the set of fungible tokens comprising a number (N) tokens which collectively represent 100% ownership of the non-fungible token.

13. The method of claim 12, wherein the smart contract is further configured to:
administer buy out procedures in which a buyout user may obtain N tokens which collectively represent 100% ownership of the first asset under rules that prevent or discourage holdouts, the buyout procedures comprising:
receiving a buyout offer from the buyout user to obtain a N fungible tokens representing fractionalized interest in the first asset, the buyout offer indicating a stake value of P fungible tokens held by the buyout user;
initiating a time period during which offers to purchase the P tokens at the stake value may be received; and
if no offer to purchase the P tokens at the stake value is received during the time period, transferring ownership of fungible tokens such that the buyout user holds at least N of the fungible tokens representing fractionalized interests in the first asset.

14. The method of claim 11, wherein the randomized set comprises a different number of fungible tokens of the first plurality than the second plurality.

15. The method of claim 11, further comprising selecting the fungible tokens that comprise the set of fungible tokens based, at least in part, on a market value of the fungible tokens.

16. The method of claim 11, wherein the randomized set further comprises fungible tokens of a third plurality of fungible tokens, each token of the third plurality of fungible tokens representing a fractionalized interest in a third asset.

17. The method of claim 11, further comprising transferring to the user, in response to receiving the message from the user, a second randomized set, the second randomized set comprising one or more fungible tokens representing fractionalized interests in a plurality of assets.

18. The method of claim 11, wherein the first asset and second asset are each physical assets held by a custodian.

19. The method of claim 11, further comprising receiving, from the user, at least one of a buy order and a sell order for fungible tokens of the first plurality of fungible tokens representing fractionalized interests in the first asset.

20. The method of claim 11, wherein the fungible tokens of the first plurality represent fractionalized interests in a first nonfungible token comprising data identifying the first asset, and the fungible tokens of the second plurality represent fractionalized interest in a second nonfungible token comprising data identifying the second asset.
